(19) United States
(12) Patent Application Publication
(10) Pub. No.: US 2009/0261974 A1
(43) Pub. Date: Oct. 22, 2009

(54) SYSTEM FOR WIRELESSLY MONITORING INVENTORY IN THE DISPENSING OF ITEMS

(75) Inventors: Kenneth S. Bailey, Newport Beach, CA (US); Paul Mula, San Jose, CA (US)

Correspondence Address: Law Office of Scott C Harris Inc, PO Box 1389, Rancho Santa Fe, CA, 92067, US

(73) Assignee: CLEAR-VIEW-TECHNOLOGIES, INC

(21) Appl. No.: 12/361,443

(22) Filed: Jan. 28, 2009

Related U.S. Application Data
(60) Provisional application No. 61/024,516, filed on Jan. 29, 2008.

(51) Int. Cl. G08B 13/14

(52) U.S. Cl. 340/568.1

(57) ABSTRACT

Items are automatically counted by proximity sensors, and correlated with a transaction. When items are removed from the proximity sensors, the system determines if a transaction for the proper amount was made at a time correlated to the time the item was removed. The person who was close to the proximity sensor is detected and correlated to the transaction.

This application claims priority from provisional application No. 61/024516, filed Jan. 29, 2008, the entire disclosure of which is herewith incorporated by reference.

### BACKGROUND

Restaurant inventory is often not efficiently turned into revenue. In one case study, a restaurant was found to have lost 35% of its gross alcohol sales. Such a loss, or “shrinkage,” results from alcohol that is poured but not accounted for at the cash register-a sales-and-inventory imbalance that collectively drains U.S. bars of about $10 billion annually

The losses can be from over-pouring, unauthorized freebies and theft. Literally thousands of dollars of premium liquor products are stolen and or given away each year by various disreputable members of the employment staff of various organizations including employees of the bar industry. On average the well or low end drinks cost the owners of the bars or nightclubs around $0.50 per shot, but premium liquors such as Brandy, Scotch and some Tequilas can cost the owners, as much as $3.00 per shot, or more.

Alcohol pilfering on airlines is also prevalent. Staff were found to have removed items like food and drinks, liquors, passenger amenities, like playing cards, pens, writing materials, shavers, toilet rolls etc.

An RFID product called Beverage Tracker has been suggested to help prevent losses from bartenders “overpouring” drinks or selling drinks for cash and pocketing the money. Beverage Tracker imbeds a micro chip into a liquor pour spout. Via this technology, managers can monitor exactly what is being poured, spot unacceptable pouring behavior and produce reports which show what specific pours occurred outside of standard or without a corresponding Point of Sale (POS) button push. In addition, managers and staff can produce brand consumption reports which are utilized to provide real-time visibility into inventory position for more effective inventory ordering and control of disappearing bottles. Beverage Tracker is also used in banquet operations to produce customer invoices detailing exact pouring records recorded during catering events, thereby dramatically reducing customer contention of liquor invoices and controlling liquor costs.

### SUMMARY OF THE INVENTION

It is one intention to address this industry need for a secure method to keep track of liquor inventory and to monitor employee theft of such items on a minute by minute basis, so as to catch the culprits in the act of stealing.

An embodiment describes a wireless proximity system.

Another embodiment defines a wireless weighing system.

A plurality of wireless antennas identify the items being weighed, dispensed or poured.

A system is herein described that utilizes proximity devices in a unique and transparent manner to control employee theft especially of pharmaceuticals and liquor (full bottles), employee theft of inventory, free pours of liquor, and inventory accountability. The system is comprised of proximity tags on each item or product. The tags can be solar powered. These tags are polled, scanned or read by invisible antennas connected in an array, wirelessly, so as to be indistinguishable by the employees or potential thieves of the merchandise. Each employee's ID badge, which may also be solar powered, sends a signal wirelessly, to the system computer, to let the computer know who is on duty and who is in contact with the item(s) being dispensed, as the dispensing occurs. A wireless cash register or other employee logging device, records the amount of monies received and creates a system log with time and date stamp. This gives total accountability and tracking of all employees and the amount of inventory sold, when it was sold and the selling price.

The system uses a wireless antenna array to poll the receiving antennas which are placed transparently on the shelf, well, bin, or storage cart, below or behind each item of interest. If the item is removed from the shelf, well, cart, or storage area, the wirelessly attached computer's internal software alerts the management of a theft or removal of the item, so it can be immediately determined if the item was paid for or not. The entire system can be made portable, and consists of a wireless interface connected to a computer, a central database (indicating inventory items in stock) and cost per item, and a system alarm (typically off site).

### BRIEF DESCRIPTION OF THE DRAWINGS

FIG. 1 depicts the system as might be deployed in the airlines industry to prevent employee theft and maintain inventory controls on a drink cart as is customarily used in flight.

FIG. 2 depicts the system deployed in a typical nightclub environment where the system is transparent to both the patrons and the nightclub employees to prevent over pours, shrinkage from employee theft of cash and inventory controls.

FIG. 3 depicts the detailed design of the employee identification badge and internal RF components as might be deployed in the present invention.

FIG. 4 depicts the flow of the embedded software routine as might be utilized in the P/C or server computer of the present invention.

FIG. 5 depicts the report format that might be utilized in the present invention to allow the management of the Company to determine which employees are not following procedures or who are guilty of employee theft or shrinkage due to employee theft.

FIG. 6 depicts the block diagram as might be deployed in the present invention.

FIG. 7 depicts the components as might be utilized in the weighing portion of the present invention as described herein.

### DETAILED DESCRIPTION

The present embodiment this invention describes a system that wirelessly weighs, and tracks inventory of pharmaceuticals (such as prescriptive drugs) or alcohol sales, as well as “shrinkage” due to employee pilfering and theft.

An embodiment describes a wireless weighing pad(s) 100 which hold the alcohol or other product to be monitored. The pad may be solar powered, or battery powered. A wireless proximity tag reader 105 reads one or more tags in proximity of the pad. An array of wireless receiving antennas 110 transmit and receive signals over a wireless interface (such as Zig-Bee, Bluetooth, or Wi-Max). The information is sent to a central database record of existing inventory items stored in a server. The tags may be in an array, and the system may detect when certain items are removed from the array.

A wireless, e.g., solar powered, employee name tag transmits a signal to identify the employees on duty and the items they sell or dispense. The server also receives information indicative of the employee.

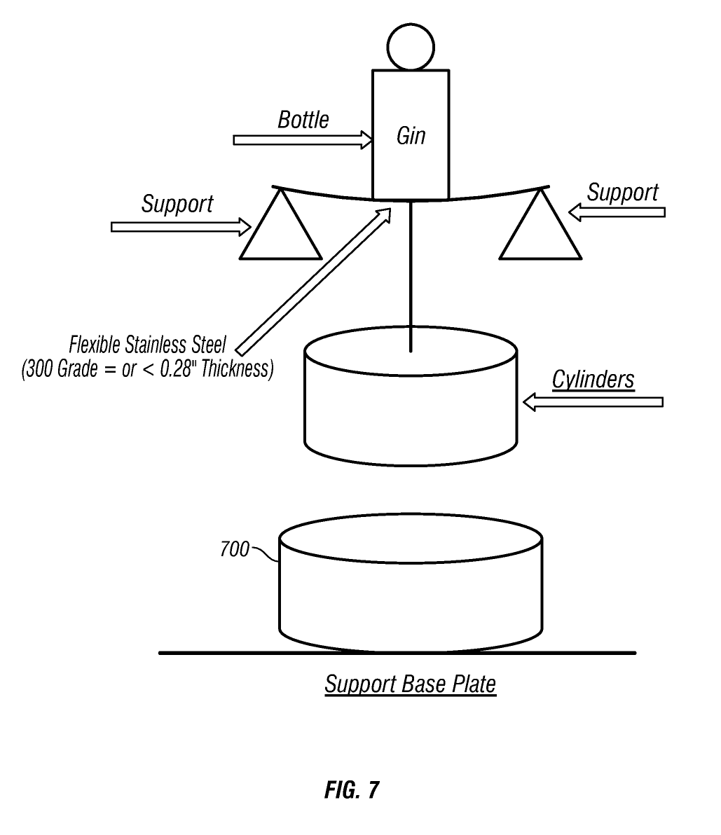

In the case of liquor sold by the ounce or shot, or pills sold by the number rather than by the bottle, miniature weight sensing pads are used that are constructed as shown in FIG. 7 herein. The computer can monitor the number of pills dispensed, the amount of drinks poured, and the amount of bottles taken from the shelf or storage area. This is compared to the amount of money received during a given period of time. An accurate account of sales versus theft by employee pilfering can be made or determined based on this information.

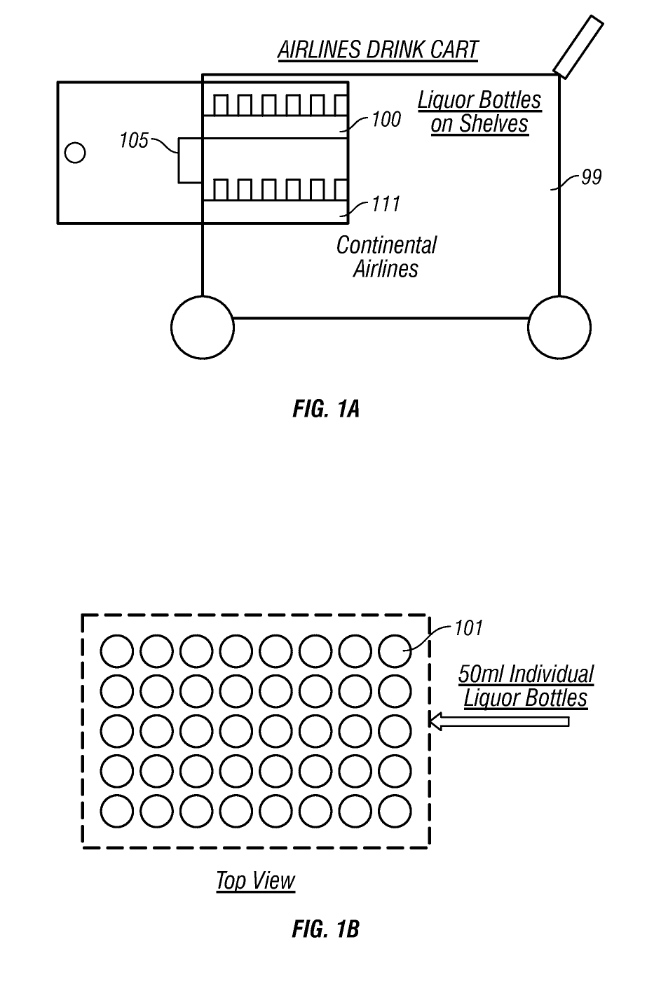

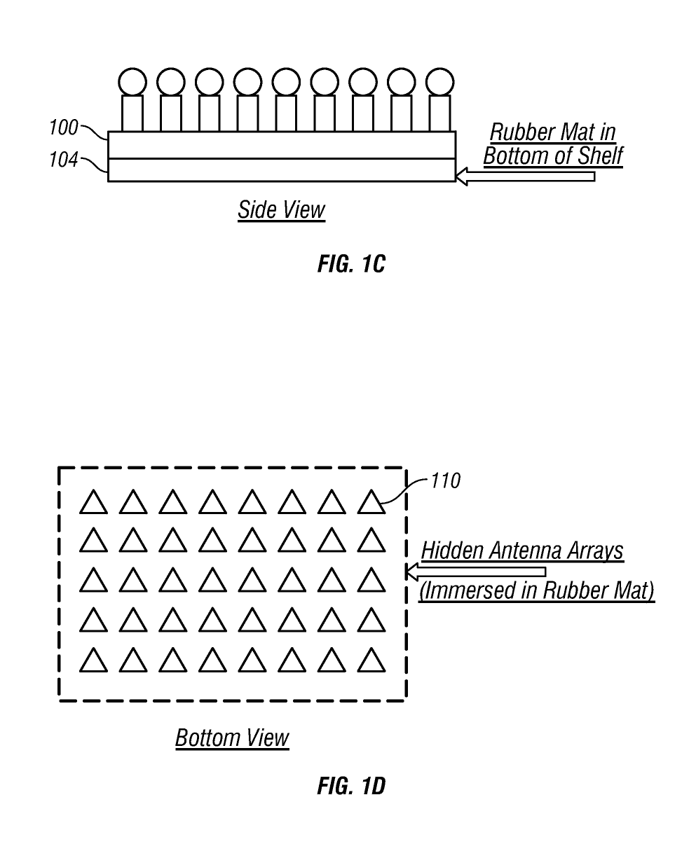

As an initial step, the items in inventory can be manually entered into the inventory database by key entry, barcode scanner, or by RFID tag scanning. The items are then placed in their respective storage areas or container or bin for sale or dispensing. FIG. 1 shows an array of items on the pad.

An alternative embodiment may weigh the items and may determine items added or removed based on the weight.

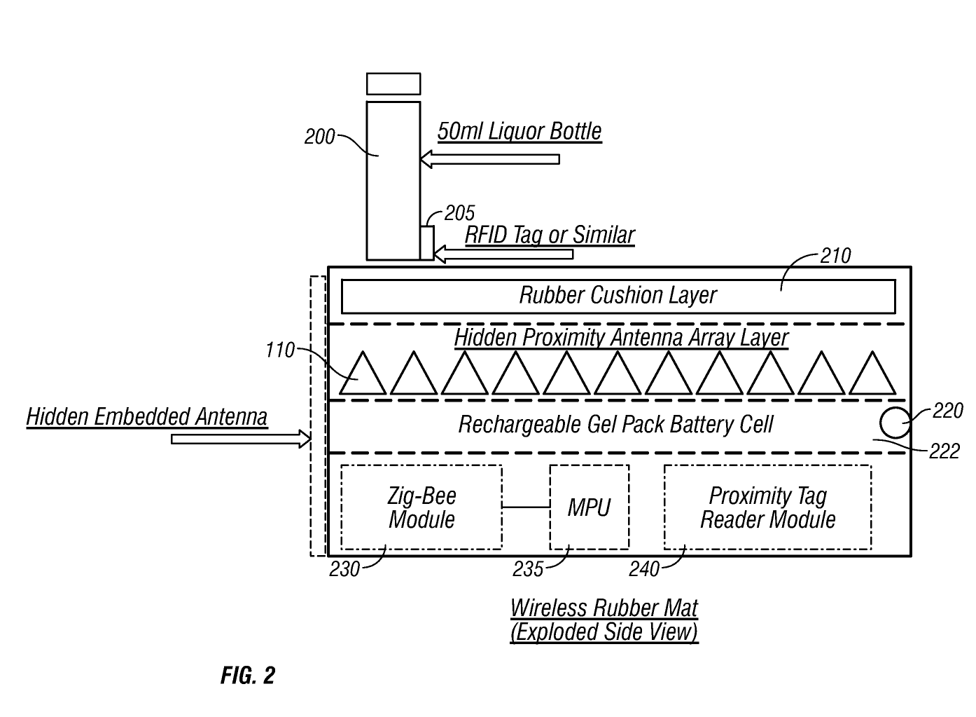

FIG. 2 shows how each item such as 200 has previously been tagged with a proximity tag 205, e..g, a Mi-Fare I-CODE device, such as Philips NPX part number SL2FLS1101DV. This may be solar powered by a ring of lights located within the resting pad on which each bottle sits (also known as “The Halo System”™). The tagged items having been placed or stored in a bin, above or next to a transparent, wireless tag reading antenna 110, are connected to the I-CODE reader chip. This is attached wirelessly to the system computer. The computer reads the information, and transfers this to the central database of the computing device as inventory in stock ready for sale or dispensing.

When a tagged item is removed from its bin, slot, or stored location, an event is triggered by the wireless antenna attached to the proximity device which time and date stamps the event's occurrence. in an embodiment where there is also a cash register, key data entered on the wireless cash register or logged into the computer wirelessly by various other methods indicating a sale has been made is also monitored. The amount and time of the sale is compared to the amount of monies entered into the transaction recording device or cash register. This is compared to the stored data to determine if the amount received matches the amount owed for the item.

If the amount received by the wireless cash register or other device, matches the amount that was expected to be received, then the system log records a successful transaction. If there is no amount entered into the system's wireless cash register or other system device for recording transactions, or the incorrect amount is entered, then an alarm can be set to alert the manger or system administrator to a breach in the system, e.g., an employee theft from the inventory. After the item is sold, the system computer updates the inventory database.

One important feature of this system is in the fact that the employee will not be made aware of the system having been installed (as it is transparent to the user) until such time as a theft or other discrepancy occurs. This will help weed out the bad employees and catch them in the act of stealing. FIG. 1 illustrates the embodiment where the group low are placed on shelves within a liquor card. The liquor card 99 can hold one or more Macs 100 which hold liquor bottles thereon. The individual liquor bottles 101 can be located on top of the Mets. Each liquor bottle can have a miniature proximity Sensor therein, which is in turn detected by an antenna array that is located within the bottom portion of the shelf 104. FIG. 1 shows there being two different maps within the drink cart shown as 100, 111. However, it should be understood that there can be a number of these items. The drink cart itself is shown in FIG. 1A, and a top view showing the bottles is shown in FIG. 1B. FIG. 1C shows the side view of the mat, while FIG. 1D shows a view of the antennas within the mat.

FIG. 2 illustrates an exploded side view of the mat, showing the bottles with RFID or other proximity tags 205. These are located on a rubber cushion layer 210 underneath which is the antenna array layer. A battery 220 operates the system, and allows recharging the battery through the port 222. A wireless module 230 reports information about which bottle is on which portion of the cushion layer. This is done in conjunction with the microprocessor 235, and a proximity reader 240.

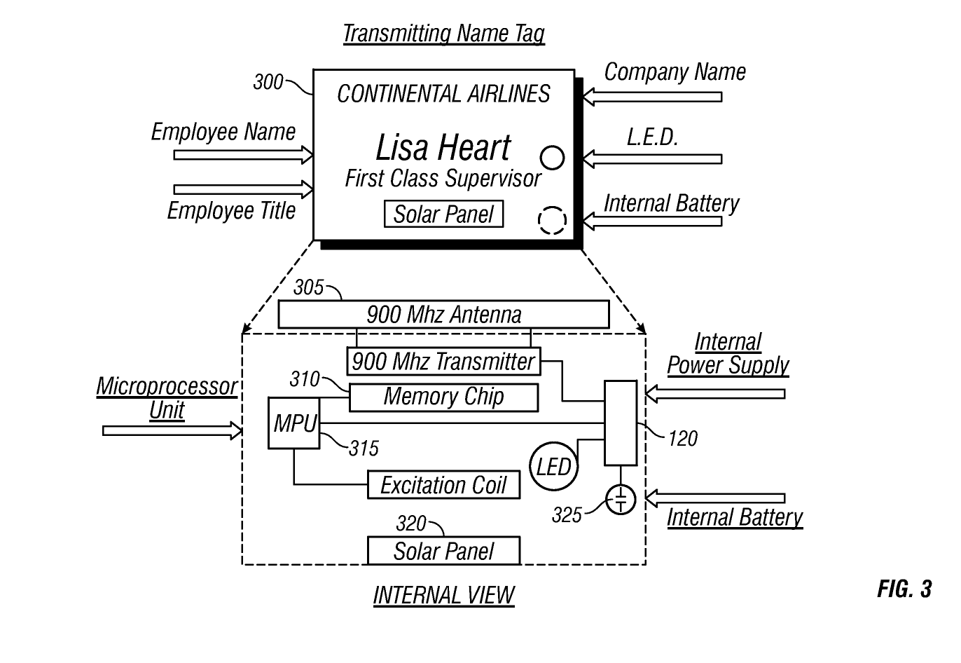

FIG. 3 shows an embodiment which connects with wireless proximity tags for a person. The proximity tag 300, includes therein a transmitter and antenna 305, memory 310, processor 315, and a solar panel 320 which allows charging the internal battery 325. The name tag may transmit information indicative of the unique identity of the person.

The front surface of the name tag 300 may also include the employee name, company name, and the like, so that it can double as an ID tag.

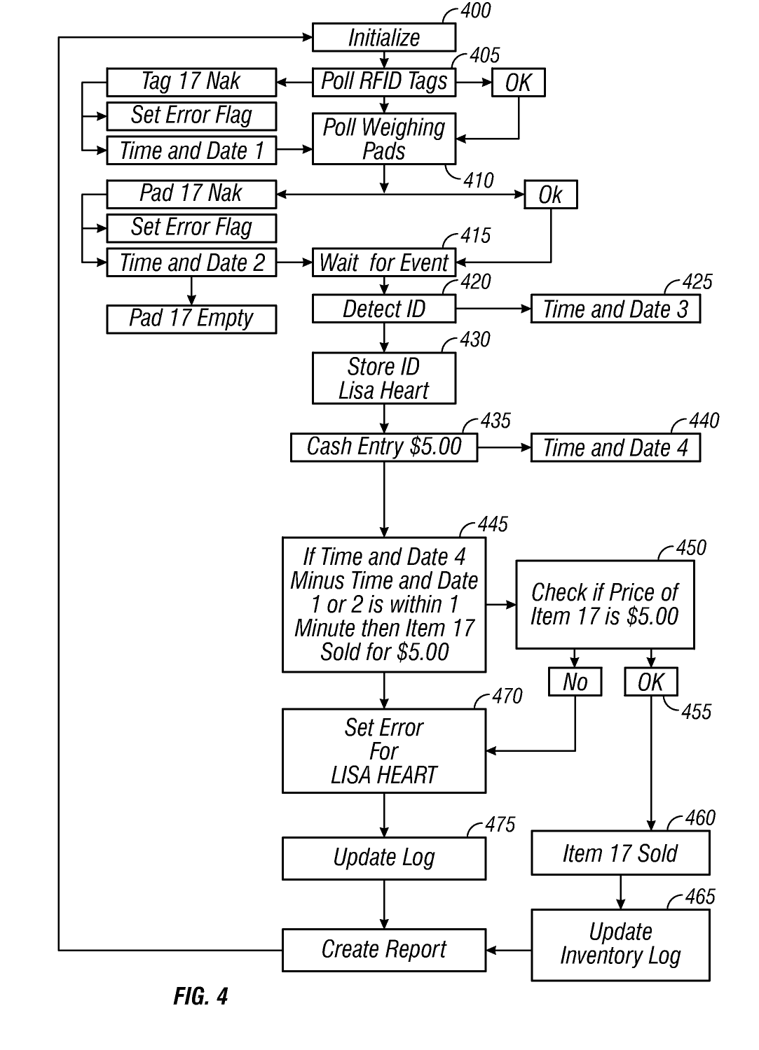

FIG. 4 shows the software flowchart that can be carried out by the microprocessor 235. At 400, the system initializes, and polls all ID tags in the area. 405 may also poll the ID tags, allowing the system to thereby determining information from either an RFID tag or from a weighing.

415 detects an event, where the event can be that a weight has changed, or an area of the array is now empty. At 420 the system detects an ID, and stores the time and date of that ID at 425. The system also stores the ID of the person who is in the proximity of the ID at 430.

At 435, a cash entry is detected. This may be from a cash register, for example the employee ringing up the information. From an airplane, this may be the employee detecting the entry of the cash. The time and date of that entry is stored 440. 445 represents logic for correlating the removal of the item with the money that has been spent. For example, if the item is removed within five minutes of the time that the money is received, then 445 may consider that the item sold for that amount of money, for example here the example being five dollars.

At 450, the system checks to see if the price for that item is really 5 dollars. If so, okay is established at 455, and 460 indicates that the item sold appropriately. The inventory log is updated at 465.

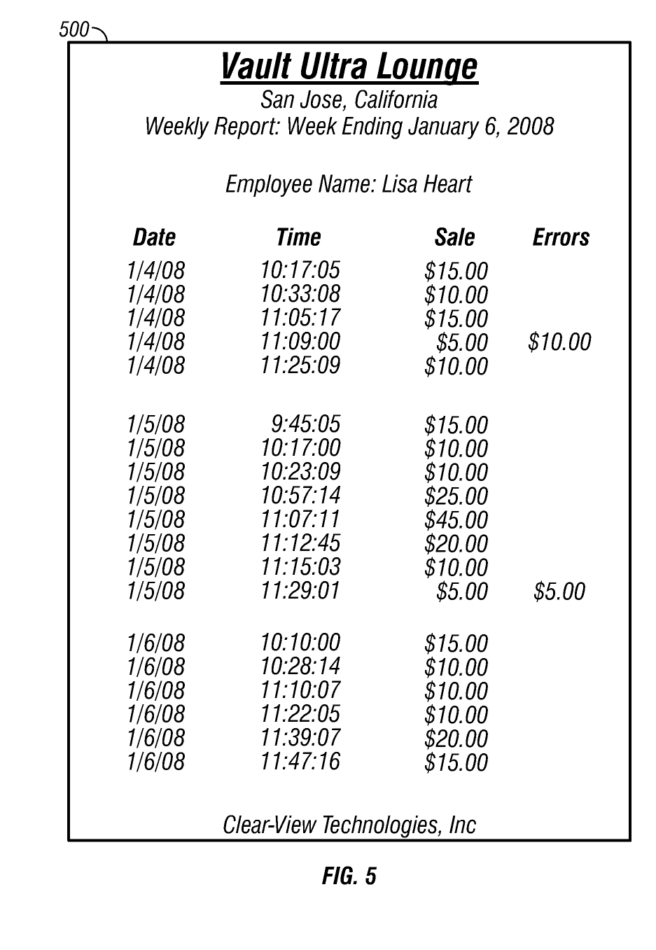

If, however, the price for the item is does not match the price that was received, or no money was received, then an error is set at 470, and the log is updated to indicate that error. The error records the item, person and time associated with the error. FIG. 5 illustrates an exemplary log, showing the time of day, sales, and error amounts. For example, the line 502 shows the user receiving $5, then they should have received $15.

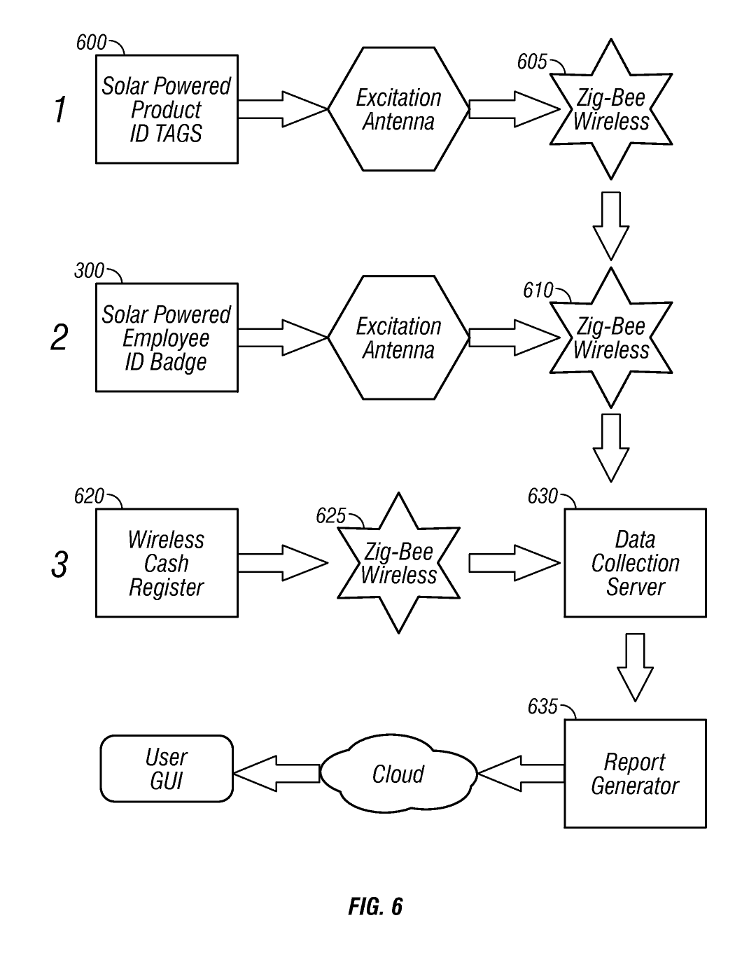

FIG. 6 illustrates a block diagram showing how a number of wireless reporting devices may operate together. The product ID tags 600 may be solar powered, and communicate via wireless communication 605. The employee ID badge 300 may also be solar powered and communicate via wireless network 610. A wireless cash register 620 may communicate via the wireless network 625. All of these items may communicate to a data collection server that receives the information from all of the items, and creates a report at 635.

In another embodiment, a scale is used for measuring the presence of the item. The scale is shown generically as 700 in FIG. 7

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other components can be used. While the above describes a location system for anti theft, the same kind wireless battery or solar powered devices can be used for other applications. While the above has described very specific forms of structure and networks that can be used, other network protocols, including but not limited to Bluetooth and others can be similarly and analogously used. In addition, other applications for this system are possible and are contemplated by the present application.

Also, the inventors intend that only those claims which use the words “means for” are intended to be interpreted under 35 USC 112, sixth paragraph. Moreover, no limitations from the specification are intended to be read into any claims, unless those limitations are expressly included in the claims.

What is claimed is:

1. A method, comprising:
In a server computer device, receiving item information from a remote device, indicative of a quantity of products on a platform;
receiving identification information about a person who is in an area of said platform, said identification information indicative of an identity of said person;
receiving transaction information indicative of transactions carried out for said items on said platforms; and
using all of said item information, said identification information and said transaction information to determine said identification information at a same time as a time when said number of items on said platform is changed and at a same time when receiving said transaction information, and using said all of said item information, said identification information and said transaction information to determine if an amount paid for a transaction matches said number of items changed at a time, and determining said identification information.

2. A method as in claim 1, wherein said information is sent wirelessly.

3. A method as in claim 1, wherein said item information is a number of discrete items on the platform.

4. A system, comprising:
A product sensor, sensing a quantity of product and producing an output signal indicative thereof;
A person sensor, sensing a person adjacent said product and producing an output signal indicative thereof;
A transaction device, detecting a transaction produced by said person, and A correlating computer, correlating said quantity of product with said person and said transaction, and producing information indicative of a change in quantity of product that does not correlate in time with a transaction appropriate to said change in quantity of product, and producing an error signal indicative thereof.

5. A device as in claim 4, wherein said product sensor, said person sensor, and said transaction device, are connected wirelessly to said correlating computer.

6. A device as in claim 4, wherein said product sensor detects a number of items on said product sensor.
